(19) United States
(12) Patent Application Publication
(10) Pub. No.: US 2024/0369982 A1
(43) Pub. Date: Nov. 7, 2024

(54) STRUCTURE MONITORING ASSEMBLY

(71) Applicant: Yadash Bankay, Uniondale, NY (US)

(72) Inventor: Yadash Bankay, Uniondale, NY (US)

(21) Appl. No.: 18/142,350

(22) Filed: May 2, 2023

(51) Int. Cl. G05B 19/042; G08B 21/02

(52) U.S. Cl. CPC G05B 19/042; G08B 21/02; G05B 2219/25011; H04W 84/18

(57) ABSTRACT

A structure monitoring assembly for detection and warning of potentially dangerous conditions within a structure includes a plurality of remote units and a base station. The remote units are mountable to the structure at various locations. Each remote unit comprises remote sensors, a remote speaker, remote light emitting diodes, and a strobe light. Each remote sensor measures a parameter corresponding to a potentially dangerous condition. The remote speaker, the remote light emitting diodes, and the strobe light broadcast an audible alert, emit a visual alert, and project a lighted arrow toward the closest exit to the remote unit upon detection of the potentially dangerous condition, respectively. The base station is in communicative engagement with the remote units and a building automation and control network (BACnet) of the structure, allowing the base station to signal the BACnet to shut off one or more utilities of the structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to monitoring assemblies and more particularly pertains to a new monitoring assembly for detection and warning of potentially dangerous conditions within a structure. There is a need for monitoring assemblies having a plurality of remote units for detecting potentially dangerous conditions throughout the structure and a base station that is integrated with a building automation and control network.

### (2) Description of Related Art Including Information Disclosed Under 37 CFR 1.97 and 1.98

The prior art relates to monitoring assemblies. The prior art does not teach a monitoring assembly having a plurality of remote units, linked to a base station, for detecting potentially dangerous conditions throughout a structure, and, more particularly, does not teach such an assembly wherein the base station can be interfaced with a building automation and control network.

### BRIEF SUMMARY OF THE INVENTION

An embodiment of the disclosure meets the needs presented above by generally comprising a plurality of remote units and a base station. The remote units are mountable to a structure at various locations within the structure. Each remote unit comprises a plurality of remote sensors, a remote speaker, a plurality of remote light emitting diodes, and a strobe light. Each remote sensor measures a respective parameter corresponding to a potentially dangerous condition so that the plurality of remote sensors measures a variety of parameters corresponding to a variety of potentially dangerous conditions. The remote speaker, the remote light emitting diodes, and the strobe light are operationally coupled with the plurality of remote sensors. The remote speaker is configured to broadcast an audible alert upon detection of a potentially dangerous condition. The remote light emitting diodes are configured to emit a visual alert upon detection of the potentially dangerous condition. The strobe light is configured to project a lighted arrow toward an exit closest to the remote unit upon detection of the potentially dangerous condition.

The base station is in communicative engagement with the plurality of remote units, whereupon the base station receives measurements of the parameters corresponding to the variety of potentially dangerous conditions. The base station also is in communicative engagement with a building automation and control network (BACnet) of the structure, which is operationally engaged to at least one utility of the structure. The base station can selectively signal the BACnet to shut off one or more utilities of the structure.

Another embodiment of the disclosure includes a structure monitoring system comprising a structure, which has a BACnet that is operationally engaged to at least one utility of the structure. The structure monitoring system also comprises a structure monitoring assembly, as per the disclosure above. The remote units of the structure monitoring assembly are mounted to the structure at various locations and are in communicative engagement with a base station of the structure monitoring assembly. Upon receipt of measurements of parameters corresponding to a variety of potentially dangerous conditions, the base station can selectively signal the BACnet to shut off one or more of the utilities of the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric perspective view of a structure monitoring assembly according to an embodiment of the disclosure.

FIG. 2 is a rear isometric perspective view of an embodiment of the disclosure.

FIG. 3 is a block diagram of an embodiment of the disclosure.

FIG. 4 is an in-use view of an embodiment of the disclosure.

FIG. 5 is a front view of an embodiment of the disclosure.

FIG. 6 is a rear view of an embodiment of the disclosure.

FIG. 7 is a rear isometric perspective view of an embodiment of the disclosure.

### DETAILED DESCRIPTION OF THE INVENTION

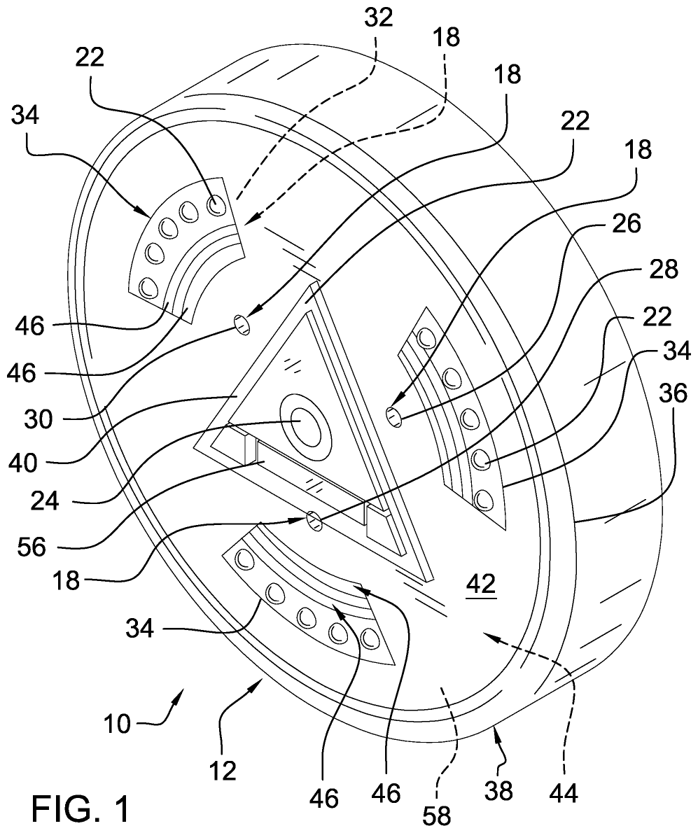

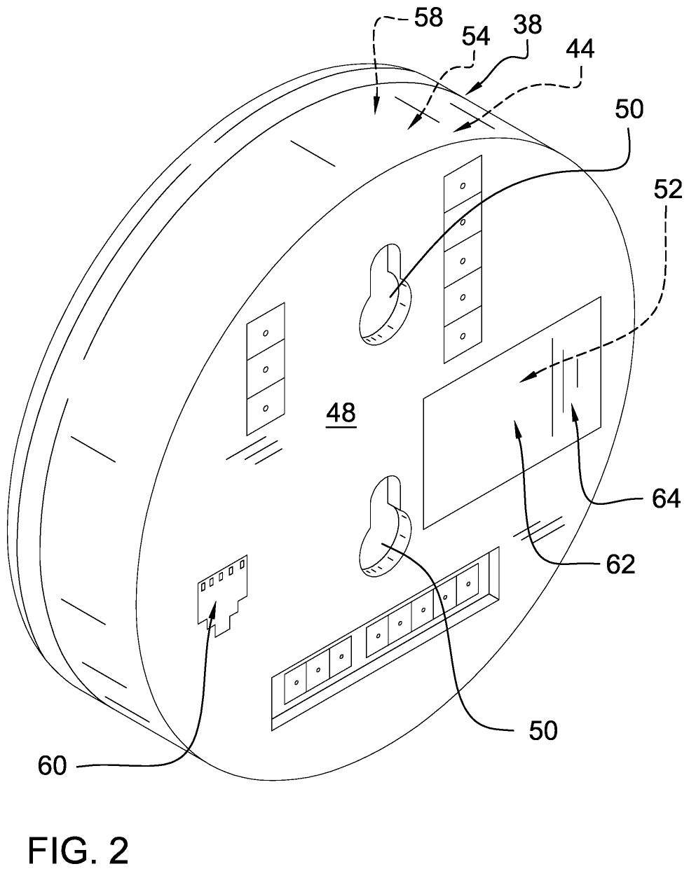

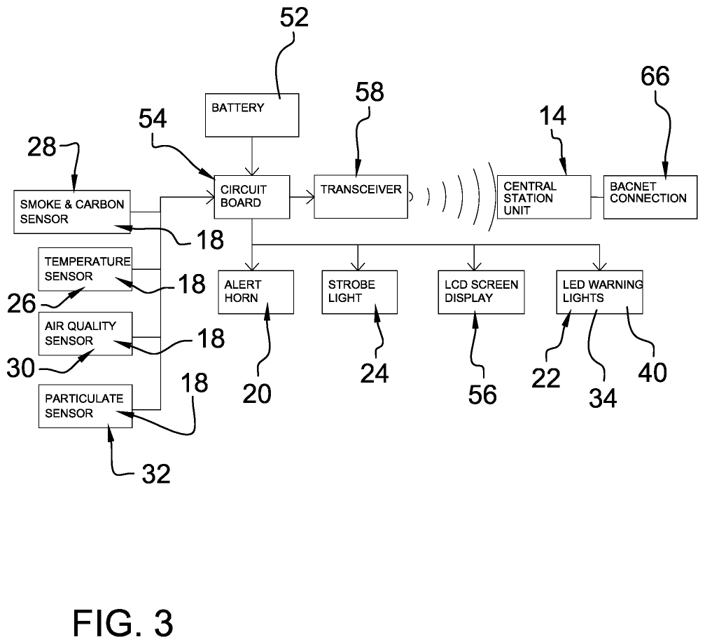

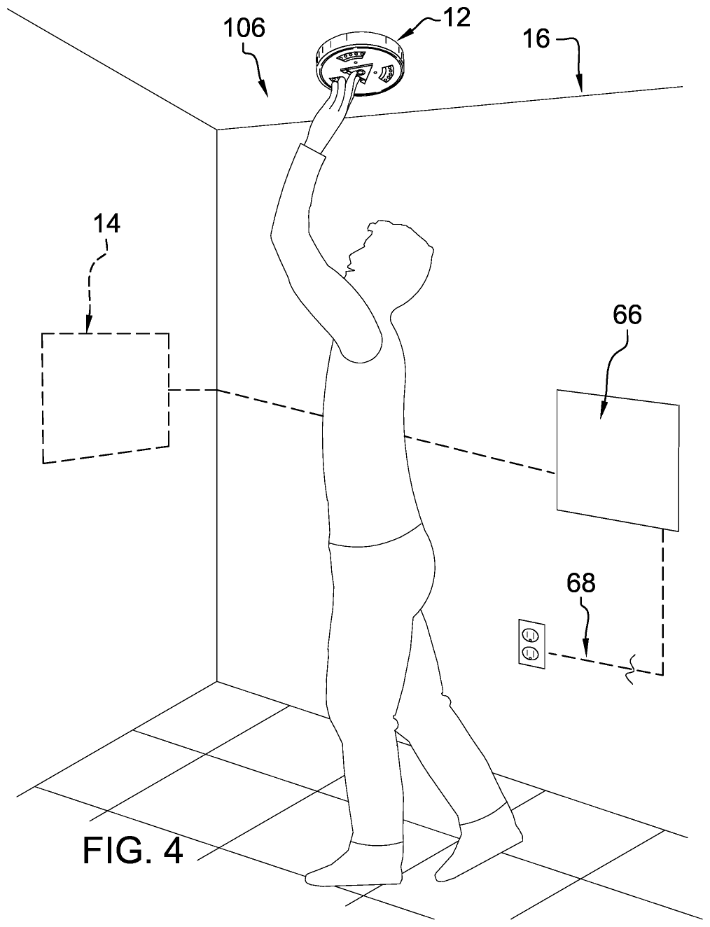

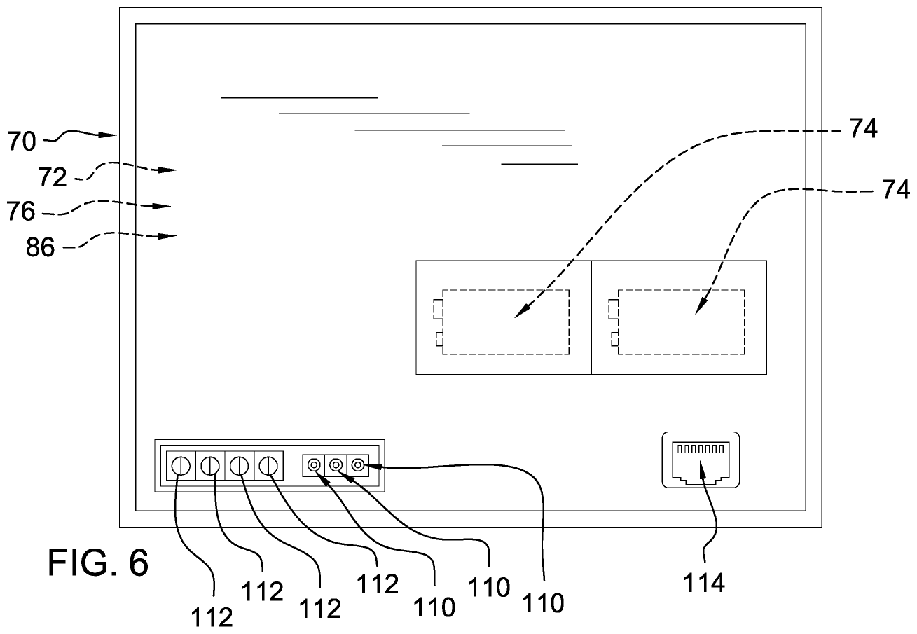

With reference now to the drawings, and in particular to FIGS. 1 through 7 thereof, a new monitoring assembly embodying the principles and concepts of an embodiment of the disclosure and generally designated by the reference numeral 10 will be described.

As best illustrated in FIGS. 1 through 7, the structure monitoring assembly 10 generally comprises a plurality of remote units 12 and a base station 14. The remote units 12 are mountable to a structure 16 at various locations within the structure 16. Each remote unit 12 comprises a plurality of remote sensors 18, a remote speaker 20, a plurality of remote light emitting diodes 22, and a strobe light 24.

Each remote sensor 18 measures a respective parameter corresponding to a potentially dangerous condition so that the plurality of remote sensors 18 measures a variety of parameters corresponding to a variety of potentially dangerous conditions. The plurality of remote sensors 18 comprises a remote temperature sensor 26, a remote smoke detector 28, a remote air quality sensor 30, a remote particulate sensor 32, and, potentially, other types of remote sensors 18, such as, but not limited to, humidity sensors, carbon monoxide sensors, or the like.

The remote temperature sensor 26 is configured to measure a temperature of air proximate to the remote unit 12. The remote smoke detector 28 is configured to detect smoke proximate to the remote unit 12. The remote air quality sensor 30 is configured to measure levels of ozone, nitrogen dioxide, and sulphur dioxide, or the like, in the air proximate to the remote unit 12. The remote particulate sensor 32 is configured to measure a level of particulates in the air proximate to the remote unit 12.

The remote speaker 20, the remote light emitting diodes 22, and the strobe light 24 are operationally coupled with the plurality of remote sensors 18. The remote speaker 20 is configured to broadcast an audible alert upon detection of a potentially dangerous condition. The remote light emitting diodes 22 are configured to emit a visual alert upon detection of the potentially dangerous condition. While a large number of configurations of the remote plurality of light emitting diodes 22 can be envisioned and are anticipated by the present invention, FIG. 1 depicts one such configuration, wherein the remote light emitting diodes 22 are arrayed in three perimeter sets 34, positioned proximate to a perimeter 36 of a remote housing 38 of the remote unit 12, and a triangular set 40, which is centrally positioned on a front face 42 of the remote housing 38. The strobe light 24 is configured to project a lighted arrow toward an exit closest to the remote unit 12 upon detection of the potentially dangerous condition. The present invention anticipates the lighted arrow being projected upon a floor or a wall of the structure 16 between the remote unit 12 and the closest exit, with the lighted arrow pointing toward the closest exit.

Each remote unit 12 comprises a remote housing 38, which defines an interior space 44. The plurality of remote sensors 18 is attached to the remote housing 38. The remote sensors 18 are positioned either in the interior space 44 or upon the front face 42 of the remote housing 38. The remote speaker 20 and the strobe light 24 are attached to the front face 42. The front face 42 has a plurality of slots 46 positioned therein to vent the interior space 44 and to allow for air to come into contact with the remote particulate sensor 32. A back face 48 of the remote housing 38 has a set of keyhole slots 50 positioned therein. Each keyhole slot 50 is configured for insertion of a respective article of mounting hardware (not shown), such as a screw or a bolt, to mount the remote housing 38 to a wall or to a ceiling of the structure 16.

Each remote unit 12 also comprises a remote battery 52 and a microcontroller 54 and may comprise a display panel 56, a remote transceiver 58, and a remote ethernet port 60. The remote battery 52 is attached to the remote housing 38 and is positioned in the interior space 44. The back face 48 has a cutout 62 positioned therein, proximate to the remote battery 52, so that the remote battery 52 is accessible to a user. A plate 64 is selectively attachable to the remote housing 38 to close the cutout 62.

The microcontroller 54 and the remote transceiver 58 are attached to the remote housing 38 and are positioned in the interior space 44. The microcontroller 54 is operationally engaged to the remote battery 52, the plurality of remote sensors 18, the remote speaker 20, the plurality of remote light emitting diodes 22, the strobe light 24, the remote transceiver 58, the display panel 56, and the remote ethernet port 60. The display panel 56 and the remote ethernet port 60 are attached to the front face 42 and the back face 48 of the remote housing 38, respectively. The display panel 56 is configured to display the measurements of the parameters from the remote sensors 18. The remote ethernet port 60 is configured to wire the remote unit 12 to the base station 14.

The present invention also anticipates the remote unit 12 comprising an antennae, which, in combination with the remote ethernet port 60, would enable the remote unit 12 to function as a wireless access point. Additionally, the remote ethernet port 60 may be configured to Power over Ethernet standards, thereby allowing the remote unit 12 to be powered via the remote ethernet port 60, with the remote battery 52 serving as an emergency power backup. The present invention also anticipates each remote unit 12 comprising a remote camera (not shown), thereby allowing for remote monitoring of the structure 16. The remote monitoring may be enabled by programming code positioned on an electronic device of the user, such as a smartphone.

The base station 14 is in communicative engagement with the plurality of remote units 12, wherefrom the base station 14 receives measurements of the parameters corresponding to the variety of potentially dangerous conditions. The base station 14 also is in communicative engagement with a building automation and control network (BACnet) 66 of the structure 16, which is operationally engaged to at least one utility 68 of the structure 16. The base station 14 selectively signals the BACnet 66 to shut off one or more utilities 68 of the structure 16. In addition to shutting off one or more utilities 68, the present invention anticipates the base station 14 being configured to signal the BACnet 66 to actuate safety systems that might be incorporated into the structure 16, such as, but not limited to, fire suppression systems, venting systems (for example, to remove contaminated air), or the like. Communicative engagement between the base station 14 and the remote units 12 and between the base station 14 and the BACnet 66 is anticipated to be accomplished by one or both of wiring and wireless means.

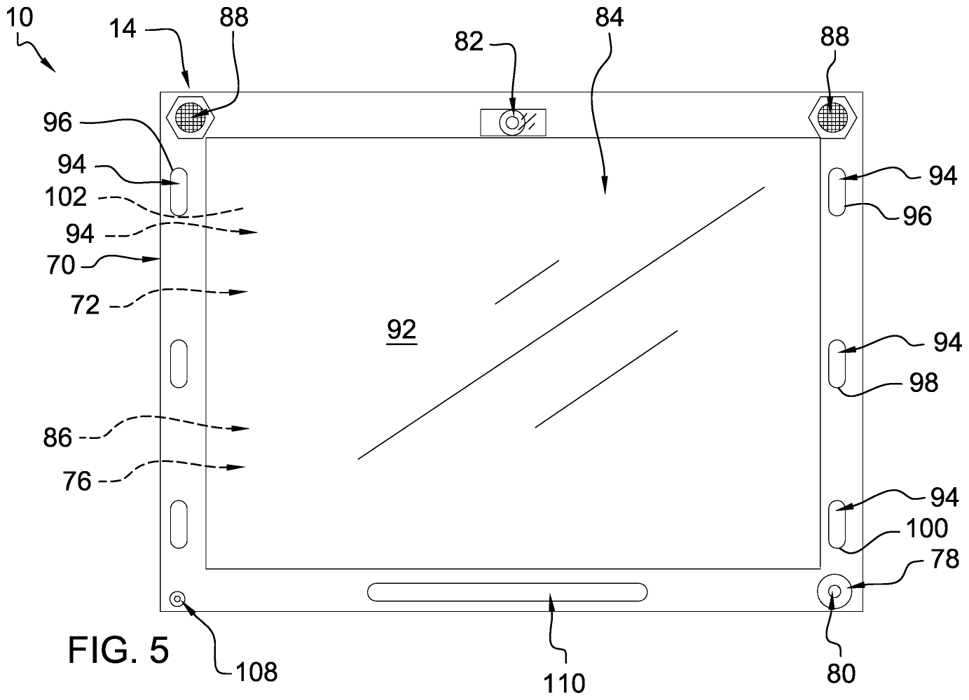

The base station 14 comprises a base housing 70, which defines an internal space 72. A base battery 74 and a microprocessor 76 are attached to the base housing 70 and are positioned in the internal space 72, with the microprocessor 76 being operationally engaged to the base battery 74. The present invention also anticipates power connectors 110 attached to the base housing 70 for connecting the base station 14 to a source of electrical current. As is shown in FIG. 5, the base station 14 also may include a power button 78 and a power indicator light 80. Also as is shown in FIG. 5, the present invention anticipates the base station 14 comprising a base camera 82 and a microphone 108, thereby allowing for remote monitoring of an area proximate to the base station 14 and potentially for facial recognition and voice recognition to access the base station 14.

The base station 14 also may comprise a touchscreen 84, a base transceiver 86, a base speaker 88, and a plurality of base light emitting diodes 90. The touchscreen 84, the base speaker 88, and the base light emitting diodes 90 are attached to a forward face 92 of the base housing 70 and are operationally engaged to the microprocessor 76. The touchscreen 84 allows for entry of commands into the microprocessor 76 and displays the measurements of the parameters corresponding to the variety of potentially dangerous conditions. The touchscreen 84 also could be employed to indicate or flash a warning of a potentially dangerous condition, or the warning may be visually communicated by a plurality of base light emitting diodes 110 attached to the forward face 92 of the base housing 70. The base transceiver 86 is attached to the base housing 70, is positioned in the internal space 72, and is configured to receive the measurements of the parameters corresponding to the variety of potentially dangerous conditions from plurality of remote units 12. The base speaker 88 and the base light emitting diodes 90 are configured to broadcast an audible alert and to emit a visual alert upon detection of the potentially dangerous condition, respectively.

The base station 14 also may comprise a plurality of base sensors 94, with each base sensor 94 being attached to the base housing 70. Each base sensor 94 is operationally engaged to the microprocessor 76 and is configured to measure a respective parameter corresponding to a potentially dangerous condition so that the plurality of base sensors 94 measures a variety of parameters corresponding to a variety of potentially dangerous conditions. The plurality of base sensors 94 comprises a base temperature sensor 96, a base smoke detector 98, a base air quality sensor 100, and a base particulate sensor 102. The base temperature sensor 96 is configured to measure a temperature of air proximate to the base station 14. The base smoke detector 98 is configured to detect smoke proximate to the base station 14. The base air quality sensor 100 is configured to measure levels of ozone, nitrogen dioxide, and sulphur dioxide, or the like, in the air proximate to the base station 14. The base particulate sensor 102 is configured to measure a level of particulates in the air proximate to the base station 14.

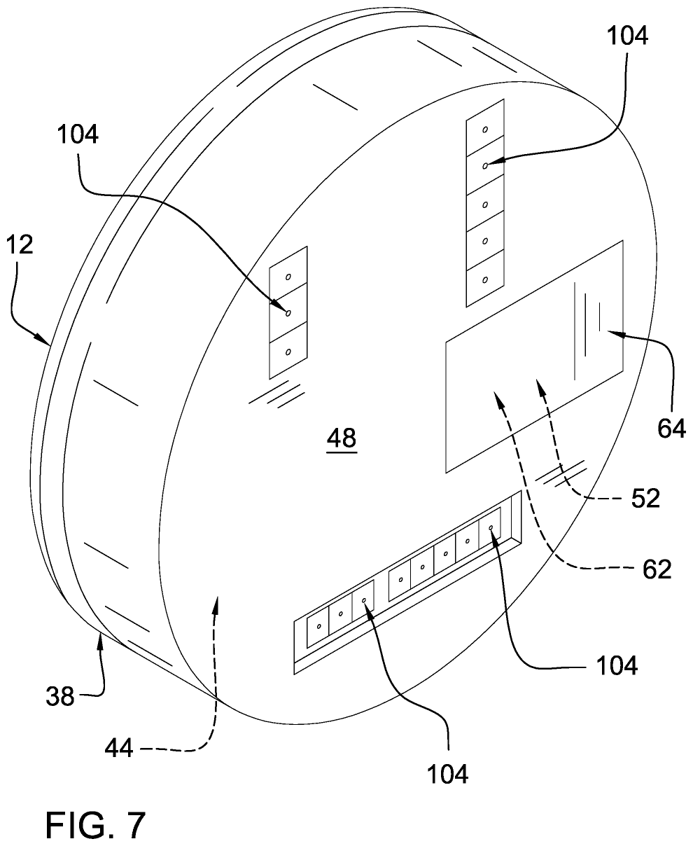

As is shown in FIG. 7, the present invention also anticipates each remote unit 12 having a plurality of remote connectors 104 attached to its back face 48. The remote connectors 104 of each remote unit 12 would engage corresponding connectors of a respective remote base unit (not shown) of a plurality of remote base units. In this embodiment, the remote base unit could incorporate some of the elements of the remote unit 12, such as the remote transceiver 58. The base station 14 also may comprise a set of base connectors 112 and a base ethernet port 114, allowing for wired connection of the base station 14 to the plurality of remote units 12 and to a router (not shown).

The present invention also anticipates a structure monitoring system 106, which comprises a structure 16 having a BACnet 66 that is operationally engaged to at least one utility 68 of the structure 16. The structure monitoring system 106 also comprises a structure monitoring assembly 10, as per the specification above. The remote units 12 of the structure monitoring assembly 10 are mounted to the structure 16 at various locations within the structure 16 and are in communicative engagement with a base station 14 of the structure monitoring assembly 10. Remote sensors 18 of the remote units 12 measure parameters corresponding to potentially dangerous conditions and selectively actuate the remote speakers 20, the remote light emitting diodes 22, and the strobe lights 24 to broadcast audible alerts, to emit visual alerts, and to project lighted arrows toward the closest exits, respectively, upon detection of a potentially dangerous condition. Upon receipt of measurements of the parameters corresponding to the variety of potentially dangerous conditions, the base station 14 can selectively signal the BACnet 66 to shut off one or more of the utilities 68 of the structure 16.

In use, the remote units 12 are mounted at various points with a structure 16. The base station 14 is installed in a convenient location and is communicatively engaged with the remote units 12 and a BACnet 66 of the structure 16. The remote sensors 18 measure parameters corresponding to potentially dangerous conditions and selectively actuate the remote speakers 20, the remote light emitting diodes 22, and the strobe lights 24 to broadcast audible alerts, to emit visual alerts, and to project lighted arrows toward closest exits, respectively, upon detection of a potentially dangerous condition. Upon receipt of measurements of the parameters corresponding to the variety of potentially dangerous conditions, the base station 14 can selectively signal the BACnet 66 to shut off one or more of the utilities 68 of the structure 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A structure monitoring assembly comprising:
a plurality of remote units, the remote units of the plurality of remote units being mountable to a structure at various locations within the structure, each remote unit comprising:
a plurality of remote sensors, each remote sensor of the plurality of remote sensors measuring a respective parameter corresponding to a potentially dangerous condition, such that the plurality of remote sensors measures a variety of parameters corresponding to a variety of potentially dangerous conditions;
a remote speaker, the remote speaker being operationally coupled with the plurality of remote sensors and configured for broadcasting an audible alert upon detection of a potentially dangerous condition;
a plurality of remote light emitting diodes, the plurality of remote light emitting diodes being operationally coupled with the plurality of remote sensors and configured for emitting a visual alert upon detection of the potentially dangerous condition; and
a strobe light, the strobe light being operationally coupled with the plurality of remote sensors and configured for projecting a lighted arrow toward an exit closest to the remote unit upon detection of the potentially dangerous condition; and
a base station, the base station being in communicative engagement with the plurality of remote units, wherefrom the base station receives measurements of the parameters corresponding to the variety of potentially dangerous conditions, the base station being in communicative engagement with a building automation and control network (BACnet) of the structure, which is operationally engaged to at least one utility of the structure, whereupon the base station selectively signals the BACnet for shutting off one or more utilities of the structure.

2. The structure monitoring assembly of claim 1, wherein the plurality of remote sensors comprises:
a remote temperature sensor, the remote temperature sensor being configured for measuring a temperature of air proximate to the remote unit;
a remote smoke detector, the remote smoke detector being configured for detecting smoke proximate to the remote unit;
a remote air quality sensor, the remote air quality sensor being configured for measuring levels of ozone, nitrogen dioxide, and sulphur dioxide in the air proximate to the remote unit; and
a remote particulate sensor, the remote particulate sensor being configured for measuring a level of particulates in the air proximate to the remote unit.

3. The structure monitoring assembly of claim 1, wherein each remote unit comprises:
a remote housing defining an interior space, the remote sensors of the plurality of remote sensors being attached to the remote housing and positioned either in the interior space or upon a front face of the remote housing, the remote speaker, the plurality of remote light emitting diodes, and the strobe light being attached to the front face, the front face having a plurality of slots positioned therein for venting the interior space;
a remote battery, the remote battery being attached to the remote housing and positioned in the interior space;
a microcontroller, the microcontroller being attached to the remote housing and positioned in the interior space, the microcontroller being operationally engaged to the remote battery, the plurality of remote sensors, the remote speaker, the plurality of remote light emitting diodes, and the strobe light; and
a remote transceiver, the remote transceiver being attached to the remote housing, positioned in the interior space, and operationally engaged to the microcontroller.

4. The structure monitoring assembly of claim 3, further including a display panel, the display panel being attached to the front face of the remote housing and operationally engaged to the microcontroller.

5. The structure monitoring assembly of claim 3, further including a remote ethernet port, the remote ethernet port being attached to a back face of the remote housing and operationally engaged to the microcontroller.

6. The structure monitoring assembly of claim 3, wherein the back face of the remote housing has a set of keyhole slots positioned therein, wherein each keyhole slot of the set of keyhole slots is configured for insertion of a respective article of mounting hardware for mounting the remote housing to a wall or to a ceiling of the structure.

7. The structure monitoring assembly of claim 3, further including:
a back face of the remote housing having a cutout positioned therein proximate to the remote battery, such that the remote battery is accessible to a user; and
a plate, the plate being selectively attachable to the remote housing for closing the cutout.

8. The structure monitoring assembly of claim 1, wherein the base station comprises:
a base housing defining an internal space;
a base battery, the base battery being attached to the base housing and positioned in the internal space;
a microprocessor, the microprocessor being attached to the base housing, positioned in the internal space, and operationally engaged to the base battery;
a touchscreen, the touchscreen being attached to a forward face of the base housing and operationally engaged to the microprocessor;
a base transceiver, the base transceiver being attached to the base housing, positioned in the internal space, and configured for receiving the measurements of the parameters corresponding to the variety of potentially dangerous conditions from plurality of remote units;
a base speaker, the base speaker being attached to the base housing, operationally engaged to the microprocessor, and configured for broadcasting an audible alert upon detection of a potentially dangerous condition; and
a plurality of base light emitting diodes, the plurality of base light emitting diodes being attached to the base housing and operationally engaged to the microprocessor and configured for emitting a visual alert upon detection of the potentially dangerous condition.

9. The structure monitoring assembly of claim 8, further including a plurality of base sensors, each base sensor of the plurality of base sensors being attached to the base housing, operationally engaged to the microprocessor, and configured for measuring a respective parameter corresponding to a potentially dangerous condition, such that the plurality of base sensors measures a variety of parameters corresponding to a variety of potentially dangerous conditions.

10. The structure monitoring assembly of claim 9, wherein the plurality of base sensors comprising:
a base temperature sensor, the base temperature sensor being configured for measuring a temperature of air proximate to the base station;
a base smoke detector, the base smoke detector being configured for detecting smoke proximate to the base station;
a base air quality sensor, the base air quality sensor being configured for measuring levels of ozone, nitrogen dioxide, and sulphur dioxide in the air proximate to the base station; and
a base particulate sensor, the base particulate sensor being configured for measuring a level of particulates in the air proximate to the base station.

11. A structure monitoring system comprising:
a structure;
a building automation and control network (BACnet), the BACnet being operationally engaged to at least one utility of the structure;
a plurality of remote units, the remote units of the plurality of remote units being mounted to the structure at various locations within the structure, each remote unit comprising:
a plurality of remote sensors, each remote sensor of the plurality of remote sensors measuring a respective parameter corresponding to a potentially dangerous condition, such that the plurality of remote sensors measures a variety of parameters corresponding to a variety of potentially dangerous conditions;
a remote speaker, the remote speaker being operationally coupled with the plurality of remote sensors and configured for broadcasting an audible alert upon detection of a potentially dangerous condition;
a plurality of remote light emitting diodes, the plurality of remote light emitting diodes being operationally coupled with the plurality of remote sensors and configured for emitting a visual alert upon detection of the potentially dangerous condition; and
a strobe light, the strobe light being operationally coupled with the plurality of remote sensors and configured for projecting a lighted arrow toward an exit closest to the remote unit upon detection of the potentially dangerous condition; and
a base station, the base station being in communicative engagement with the plurality of remote units, wherefrom the base station receives measurements of the parameters corresponding to the variety of potentially dangerous conditions, the base station being in communicative engagement with BACnet, whereupon the base station selectively signals the BACnet for shutting off one or more of the utilities of the structure.

12. A structure monitoring assembly comprising:
a plurality of remote units, the remote units of the plurality of remote units being mountable to a structure at various locations within the structure, each remote unit comprising:
a plurality of remote sensors, each remote sensor of the plurality of remote sensors measuring a respective parameter corresponding to a potentially dangerous condition, such that the plurality of remote sensors measures a variety of parameters corresponding to a variety of potentially dangerous conditions, the plurality of remote sensors comprising:
a remote temperature sensor, the remote temperature sensor being configured for measuring a temperature of air proximate to the remote unit;
a remote smoke detector, the remote smoke detector being configured for detecting smoke proximate to the remote unit;
a remote air quality sensor, the remote air quality sensor being configured for measuring levels of ozone, nitrogen dioxide, and sulphur dioxide in the air proximate to the remote unit; and
a remote particulate sensor, the remote particulate sensor being configured for measuring a level of particulates in the air proximate to the remote unit;
a remote speaker, the remote speaker being operationally coupled with the plurality of remote sensors and configured for broadcasting an audible alert upon detection of a potentially dangerous condition;
a plurality of remote light emitting diodes, the plurality of remote light emitting diodes being operationally coupled with the plurality of remote sensors and configured for emitting a visual alert upon detection of the potentially dangerous condition;
a strobe light, the strobe light being operationally coupled with the plurality of remote sensors and configured for projecting a lighted arrow toward an exit closest to the remote unit upon detection of the potentially dangerous condition;
a remote housing defining an interior space, the remote sensors of the plurality of remote sensors being attached to the remote housing and positioned either in the interior space or upon a front face of the remote housing, the remote speaker, the plurality of remote light emitting diodes, and the strobe light being attached to the front face, the front face having a plurality of slots positioned therein for venting the interior space, a back face of the remote housing having a set of keyhole slots positioned therein, wherein each keyhole slot of the set of keyhole slots is configured for insertion of a respective article of mounting hardware for mounting the remote housing to a wall or to a ceiling of the structure;
a remote battery, the remote battery being attached to the remote housing and positioned in the interior space, the back face of the remote housing having a cutout positioned therein proximate to the remote battery, such that the remote battery is accessible to a user;
a plate, the plate being selectively attachable to the remote housing for closing the cutout;
a microcontroller, the microcontroller being attached to the remote housing and positioned in the interior space, the microcontroller being operationally engaged to the remote battery, the plurality of remote sensors, the remote speaker, the plurality of remote light emitting diodes, and the strobe light;
a remote transceiver, the remote transceiver being attached to the remote housing, positioned in the interior space, and operationally engaged to the microcontroller;
a display panel, the display panel being attached to the front face of the remote housing and operationally engaged to the microcontroller; and
a remote ethernet port, the remote ethernet port being attached to a back face of the remote housing and operationally engaged to the microcontroller;
a base station, the base station being in communicative engagement with the plurality of remote units, wherefrom the base station receives measurements of the parameters corresponding to the variety of potentially dangerous conditions, the base station being in communicative engagement with a building automation and control network (BACnet) of the structure, which is operationally engaged to at least one utility of the structure, whereupon the base station selectively signals the BACnet for shutting off one or more utilities of the structure; the base station comprising:
a base housing defining an internal space;
a base battery, the base battery being attached to the base housing and positioned in the internal space;
a microprocessor, the microprocessor being attached to the base housing, positioned in the internal space, and operationally engaged to the base battery;
a touchscreen, the touchscreen being attached to a forward face of the base housing and operationally engaged to the microprocessor;
a base transceiver, the base transceiver being attached to the base housing, positioned in the internal space, and configured for receiving the measurements of the parameters corresponding to the variety of potentially dangerous conditions from plurality of remote units;
a base speaker, the base speaker being operationally engaged to the microprocessor and configured for broadcasting an audible alert upon detection of a potentially dangerous condition; and
a plurality of base light emitting diodes, the plurality of base light emitting diodes being operationally engaged to the microprocessor and configured for emitting a visual alert upon detection of the potentially dangerous condition; and
a plurality of base sensors, each base sensor of the plurality of base sensors being attached to the base housing, operationally engaged to the microprocessor, and configured for measuring a respective parameter corresponding to a potentially dangerous condition, such that the plurality of base sensors measures a variety of parameters corresponding to a variety of potentially dangerous conditions, the plurality of base sensors comprising:
a base temperature sensor, the base temperature sensor being configured for measuring a temperature of air proximate to the base station;
a base smoke detector, the base smoke detector being configured for detecting smoke proximate to the base station;
a base air quality sensor, the base air quality sensor being configured for measuring levels of ozone, nitrogen dioxide, and sulphur dioxide in the air proximate to the base station; and
a base particulate sensor, the base particulate sensor being configured for measuring a level of particulates in the air proximate to the base station.
